(19) United States
(12) Patent Application Publication
(10) Pub. No.: US 2020/0199459 A1
(43) Pub. Date: Jun. 25, 2020

(54) SYSTEMS AND METHODS FOR PYROLYSIS OF FEEDSTOCK IN CHEMICAL FURNACES

(71) Applicant: SABIC Global Technologies B.V., Bergen op Zoom (NL)

(72) Inventors: Mohanrao RAMPURE, Riaydh (SA); Ramsey BUNAMA, Riyadh (SA)

(21) Appl. No.: 16/621,321

(22) PCT Filed: Jun. 25, 2018
(86) PCT No.: PCT/IB2018/054681

§ 371 Date: Dec. 11, 2019

Related U.S. Application Data
(60) Provisional application No. 62/526,863, filed on Jun. 29, 2017.

(51) Int. Cl. C10G 9/20; C10G 9/36; F27B 1/22; F27D 17/00; F27B 9/30; F27B 9/10

(52) U.S. Cl. CPC C10G 9/20; C10G 9/36; F27B 9/10; F27D 17/004; F27B 9/3005; F27B 1/22

(57) ABSTRACT

A furnace having a convection section with convection tubes in a convection compartment is disclosed. The convection tubes receive and preheat hydrocarbon feed primarily by convection of heat from hot flue gas that flows into in the convection section. The convection section additionally includes a perforated distributor plate that prevents flow channeling of the hot flue gas as it flows into the convection section. The furnace also includes a radiant section having radiant tubes in a radiant compartment. The radiant tubes are in fluid communication with the convection tubes so that preheated hydrocarbon feed flows from the convection section to the radiant section. The radiant section burns fuel and heats the preheated hydrocarbon feed primarily by radiation and from the hot flue gas, which flows from the radiant section into the convection section.

### CROSS REFERENCE TO RELATED APPLICATIONS

This application claims the benefit of priority of U.S. Provisional Patent Application No. 62/526,863, filed Jun. 29, 2017, which is hereby incorporated by reference in its entirety.

### FIELD OF INVENTION

The present invention generally relates to chemical furnaces, and in particular to a chemical furnace having a convection section with an internal perforated distributor plate to avoid flow channeling of flue gas flows.

### BACKGROUND OF THE INVENTION

Large furnaces are generally used in the petrochemical industry for the pyrolysis of cheap feedstock into high value chemical products. These energy intensive units are the backbone of the chemical industry value chain. Assessing and optimizing the thermal performance of chemical furnaces are of key importance to improve reliability and productivity. A key aspect of the design of chemical furnaces is the performance of the convection section where the energy content of flue gases leaving the fire box (radiant section) is utilized for pre-heating feed and fuel, and generating high quality steam before venting to atmosphere.

The tube-side fluid of a chemical furnace experiences a chronic problem of coke formation in the convection section that is used to pre-heat and vaporize the furnace feed before it is sent to the radiant section tubes for the cracking reaction. The presence of coke in the convection section hinders optimum heating of the feed, reduces furnace yield, and shortens the run length of the furnace due to frequent cleaning.

### BRIEF SUMMARY OF THE INVENTION

In embodiments of the invention, a furnace has a convection section that includes convection tubes disposed in a convection compartment. The convection tubes are adapted to receive hydrocarbon feed and to preheat the hydrocarbon feed primarily by convection of heat from hot flue gas that flows into the convection section. The convection section additionally has a perforated distributor plate that prevents flow channeling of the hot flue gas as it flows into the convection section. The furnace also has a radiant section that comprises radiant tubes disposed in a radiant compartment. The radiant tubes are in fluid communication with the convection tubes so that preheated hydrocarbon feed flows from the convection section to the radiant section. The radiant section is adapted to burn fuel and heat the preheated hydrocarbon feed primarily by radiation and from the hot flue gas. The furnace is adapted so that the hot flue gas flows from the radiant section into the convection section.

In embodiments of the invention, an apparatus includes means for preheating hydrocarbon feed by convection of heat from hot flue gas. The apparatus additionally includes means for preventing flow channeling of the hot flue gas as it flows into proximity with the hydrocarbon feed. The apparatus further includes means for heating the preheated hydrocarbon feed and producing the hot flue gas.

In embodiments of the invention, a method includes preheating hydrocarbon feed by convection of heat from hot flue gas. The method additionally includes preventing flow channeling of the hot flue gas as it flows into proximity with the hydrocarbon feed. The method further includes heating the preheated hydrocarbon feed and producing the hot flue gas.

The following includes definitions of various terms and phrases used throughout this specification.

The terms “about” or “approximately” are defined as being close to as understood by one of ordinary skill in the art. In one non-limiting embodiment the terms are defined to be within 10%, preferably, within 5%, more preferably, within 1%, and most preferably, within 0.5%.

The terms “wt. %”, “vol. %” or “mol. %” refers to a weight, volume, or molar percentage of a component, respectively, based on the total weight, the total volume, or the total moles of material that includes the component. In a non-limiting example, 10 moles of component in 100 moles of the material is 10 mol. % of component.

The term “substantially” and its variations are defined to include ranges within 10%, within 5%, within 1%, or within 0.5%.

The terms “inhibiting” or “reducing” or “preventing” or “avoiding” or any variation of these terms, when used in the claims and/or the specification, includes any measurable decrease or complete inhibition to achieve a desired result.

The term “effective,” as that term is used in the specification and/or claims, means adequate to accomplish a desired, expected, or intended result.

The use of the words “a” or “an” when used in conjunction with the term “comprising,” “including,” “containing,” or “having” in the claims or the specification may mean “one,” but it is also consistent with the meaning of “one or more,” “at least one,” and “one or more than one.”

The words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The process of the present invention can “comprise,” “consist essentially of,” or “consist of” particular ingredients, components, compositions, etc., disclosed throughout the specification.

In the context of the present invention, at least twenty embodiments are now described. Embodiment 1 is a furnace including a convection section that includes convection tubes disposed in a convection compartment, the convection tubes adapted to receive hydrocarbon feed and to preheat the hydrocarbon feed primarily by convection of heat from hot flue gas that flows into the convection section, the convection section including a perforated distributor plate adapted to prevent flow channeling of the hot flue gas as it flows into the convection section; and a radiant section that includes radiant tubes disposed in a radiant compartment, the radiant tubes in fluid communication with the convection tubes so that preheated hydrocarbon feed flows from the convection section to the radiant section, the radiant section adapted to burn fuel and heat the preheated hydrocarbon feed primarily by radiation and from the hot flue gas, wherein the furnace is adapted so that the hot flue gas flows from the radiant section into the convection section. Embodiment 2 is the furnace as set forth in embodiment 1, further including a stack section for receiving cooled flue gas from the convection section and discharging the cooled flue gas to the atmosphere. Embodiment 3 is the furnace as set forth in embodiment 1 or embodiment 2, wherein the perforated distributor plate is located in a lower ¼ of the convection section. Embodiment 4 is the furnace as set forth in any of embodiments 1 to 3, wherein the perforated distributor plate has a plurality of holes that form a free open area in a range from 0.1% to 5.5%. Embodiment 5 is the furnace as set forth in any of embodiments 1 to 4, wherein a difference in temperature between tube areas on each side of the convection tubes is not greater than 5% of average temperature. Embodiment 6 is the furnace as set forth in any of embodiments 1 to 5, wherein the perforated distributor plate is configured to provide a uniform flow distribution such that no flue gas flow channeling is evident by velocity or mass flow distribution in an area immediately below the convection tubes after passing of the hot flue gas through the perforated distributor plate. Embodiment 7 is the he furnace as set forth in any of embodiments 1 to 6, wherein the perforated distributor plate has a thickness of 3 to 13 mm. Embodiment 8 is the furnace as set forth in any of embodiments 1 to 7, wherein the hot flue gas enters the convection section and passes through the distributor plate before encountering the convection tubes. Embodiment 9 is the furnace as set forth in any of embodiments 1 to 8, wherein the hot flue gas enters the convection section from one side and passes upwardly through the distributor plate. Embodiment 10 is the furnace as set forth in any of embodiments 1 to 9, wherein the convection section is adapted so that the hot flue gas also preheats at least one of fuel or steam.

Embodiment 11 is an apparatus including means for preheating hydrocarbon feed by convection of heat from hot flue gas; means for preventing flow channeling of the hot flue gas as it flows into proximity with the hydrocarbon feed; and means for heating the preheated hydrocarbon feed and producing the hot flue gas. Embodiment 12 is the apparatus as set forth in embodiment 11, further including means for receiving cooled flue gas and discharging the cooled flue gas to the atmosphere. Embodiment 13 is the apparatus as set forth in embodiment 11 or embodiment 12, wherein the means for preventing flow channeling is configured to provide a uniform flow distribution such that no flue gas flow channeling is evident by velocity or mass flow distribution in an area immediately below the means for preheating hydrocarbon feed after passing of the hot flue gas through the means for preventing flow channeling. Embodiment 14 is the apparatus as set forth in any of embodiments 11 to 13, further including means for receiving the hot flue gas from one side and directing the hot flue gas to pass upwardly through the means for preventing flow channeling before the hot flue gas encounters the means for preheating hydrocarbon feed. Embodiment 15 is the apparatus as set forth in any of embodiments 11 to 14, further including means for preheating at least one of fuel or steam by convection of heat from hot flue gas.

Embodiment 16 is a method including the steps of preheating hydrocarbon feed by convection of heat from hot flue gas; preventing flow channeling of the hot flue gas as it flows into proximity with the hydrocarbon feed; and heating the preheated hydrocarbon feed and producing the hot flue gas. Embodiment 17 is the method as set forth in embodiment 16, further including the step of receiving cooled flue gas and discharging the cooled flue gas to the atmosphere. Embodiment 18 is the method as set forth in embodiment 16 or embodiment 17, wherein the preventing flow channeling includes providing a uniform flow distribution such that no flue gas flow channeling is evident by velocity or mass flow distribution immediately prior to preheating the hydrocarbon feed after the preventing flow channeling. Embodiment 19 is the method as described in any of embodiments 16 to 18, further including the step of receiving the hot flue gas from one side; and directing the hot flue gas to pass upwardly for the preventing flow channeling before the hot flue gas is used for the preheating hydrocarbon feed. Embodiment 20 is the method as described in any of embodiments 16 to 20, further including the step of preheating at least one of fuel or steam by convection of heat from hot flue gas.

Other objects, features and advantages of the present invention will become apparent from the following figures, detailed description, and examples. It should be understood, however, that the figures, detailed description, and examples, while indicating specific embodiments of the invention, are given by way of illustration only and are not meant to be limiting. Additionally, it is contemplated that changes and modifications within the spirit and scope of the invention will become apparent to those skilled in the art from this detailed description. In further embodiments, features from specific embodiments may be combined with features from other embodiments. For example, features from one embodiment may be combined with features from any of the other embodiments. In further embodiments, additional features may be added to the specific embodiments described herein.

### BRIEF DESCRIPTION OF THE DRAWINGS

For a more complete understanding, reference is now made to the following descriptions taken in conjunction with the accompanying drawings, in which:

FIG. 1 is a block diagram illustrating a furnace in accordance with the present disclosure;

FIG. 2 is a perspective view of a convection section of the furnace of FIG. 1;

FIG. 3 is a block diagram illustrating flow of flue gas in the convection section of FIG. 2;

FIG. 4 is a block diagram illustrating a furnace in accordance with the present disclosure;

FIG. 5 is a perspective view of a convection section of the furnace of FIG. 4;

FIG. 6 is a block diagram illustrating flow of flue gas in the convection section of FIG. 5; and

FIG. 7 is a flow diagram illustrating an example process carried out by the furnace of FIG. 4.

### DETAILED DESCRIPTION OF THE INVENTION

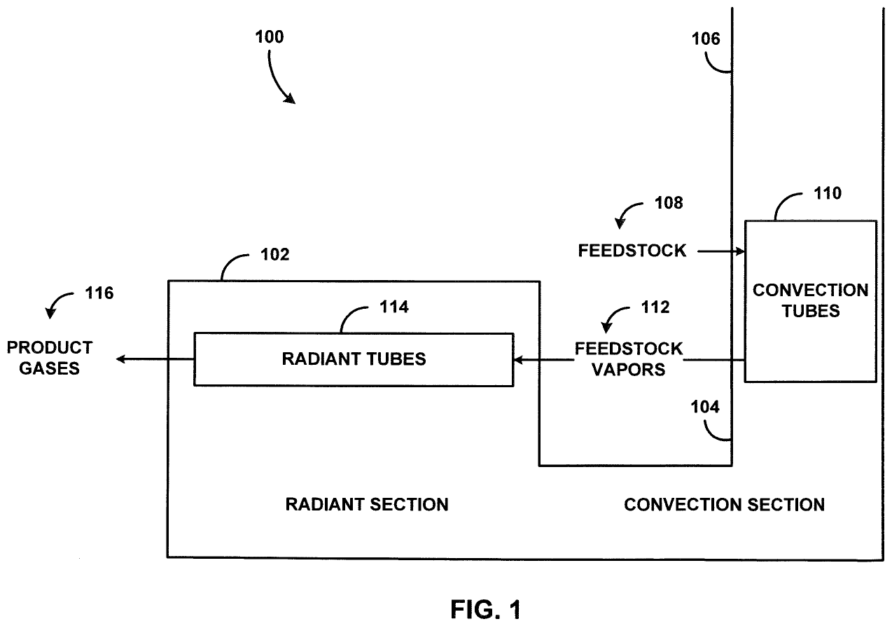

Referring to FIG. 1, furnace 100 operation for chemical processes generally is carried out with process gas entering the furnace 100 in the convection section 104 where the process stream of hydrocarbon feedstock 108 is preheated and vaporized in convection tubes 110. These feedstock vapors 112 are passed to the radiant tubes 114 in the radiant section 102 for cracking into product gases 116. The flue gases from the radiant section 102 travel towards the convection section 104 before exiting from the stack 106. The convection tubes 110 carrying the process stream need to be heated uniformly so as to avoid higher heat flux at one side that causes coking on that side, and lower heat flux on the other side that causes liquid droplets to enter the radiant section 102. This situation can happen in case of flow channeling or maldistribution of the flue gases.

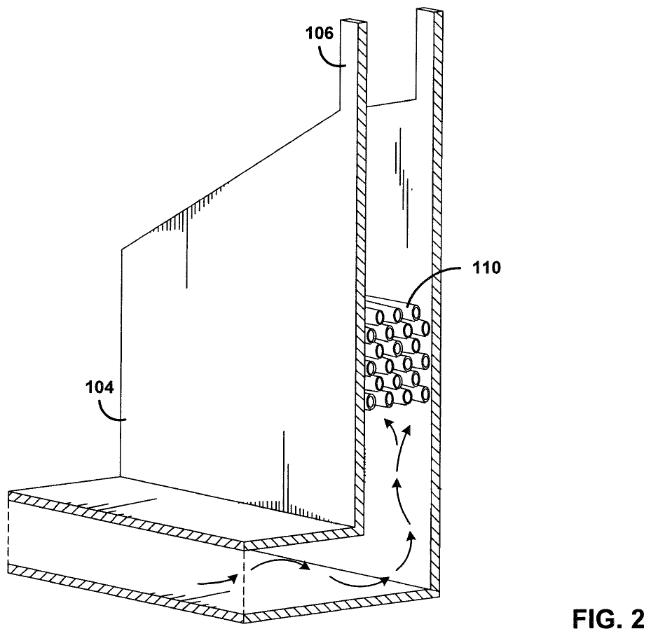

Turning to FIG. 2, the convection section 104 exhibits a side entrance by which flue gases from the radiant section are introduced from a compartment of the radiant section. A convection compartment defined by walls causes the flue gases to enter from one side and travel upwardly towards the convection tubes 110 before being received and vented to atmosphere via the stack 106. Convection tubes 110 may be formed as a bank of coils that carry a flow of hydrocarbon feedstock from a source thereof to the radiant tubes of the radiant section.

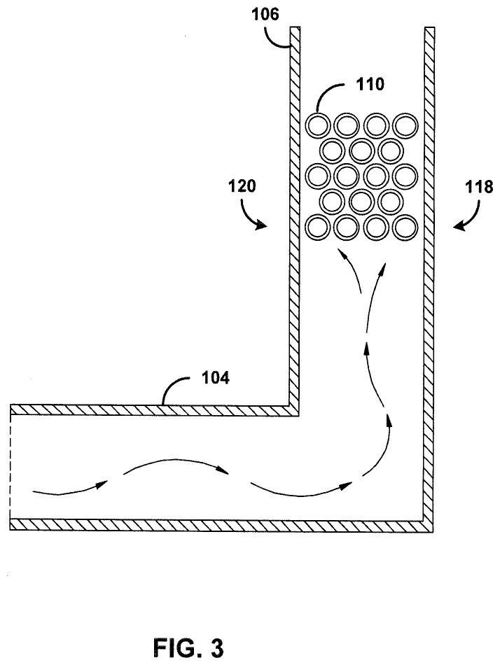

Turning to FIG. 3, study results show that flue gas flow is skewed towards one side of the convection tubes 110 due to the side entrance of the flue gases to the convection section 104 from the radiant section.

For example, the skewed flow is evidenced in that flue gas flow rate in one tube area is greater than flue gas flow rate in another tube area by at least 30%. Alternatively or additionally, the difference in the flow rates on each side of the convection tubes is much greater than 30% of average flow rate, and is typically greater than 50% of average flow rate.

Hence, non-uniform heating of the convection tubes 110 occurs in which one side of the convection tubes 110 is overheated and another side of the convection tubes 110 is less heated. For example, a side 118 of the convection tubes 110 furthest from the radiant section may be overheated and another side 120 of the convection tubes 110 nearest to the radiant section may be underheated. A difference in temperature between the two sides is much more than 20% of average temperature, and is typically greater than 30% of average temperature. The overheated side 118 of the convection tubes 110 experiences accelerated feed coke formation and the less heated side 120 does not fully vaporize the feed before it enters the radiant section tubes.

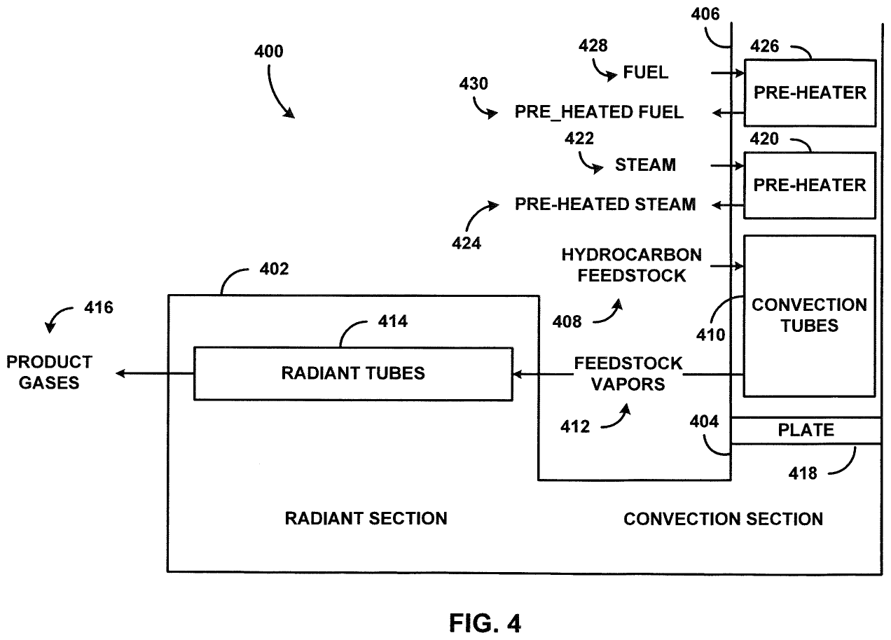

Turning to FIG. 4, a furnace 400 according to the present disclosure may exhibit features similar to the furnace of FIG. 1. For example, furnace 400 operation for chemical processes may be carried out with process gas entering the furnace 400 in the convection section 404 where the process stream of hydrocarbon feedstock 408 is preheated and vaporized in convection tubes 410. These feedstock vapors 412 are passed to the radiant tubes 414 in the radiant section 402 for cracking into product gases 416. The flue gases from the radiant section 402 travel towards the convection section 404 and preheat feedstock 408 in convection tubes 410 before exiting from the stack 406. Additionally, furnace 400 has a perforated distribution plate 418 that prevents flow channeling or maldistribution of the flue gases, and thus avoids the problems detailed above. It is also envisioned that furnace 400 may have a pre-heater 420, such as one or more coils, that receive water and/or steam 422 and produce preheated water and/or steam 424 by convection of heat from the hot flue gas that flows into the convection section. Alternatively or additionally, it is envisioned that furnace 400 may have a pre-heater 426, such as one or more coils, that receives fuel 428 and produces preheated fuel 430 by convection of heat from the hot flue gas that flows into in the convection section.

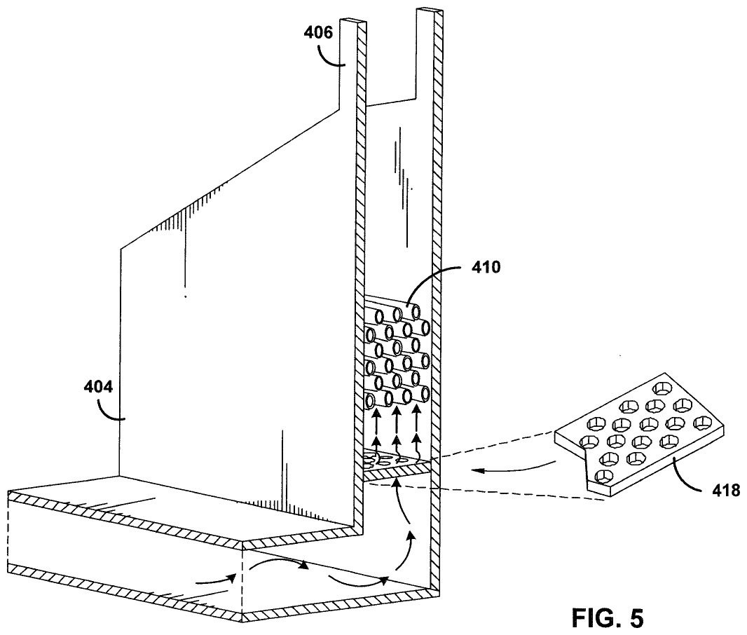

Turning to FIG. 5, the convection section 404 exhibits a side entrance by which flue gases from the radiant section are introduced from a compartment of the radiant section. A convection compartment defined by walls causes the flue gases to travel upwardly towards the convection tubes 410 before being received and vented to atmosphere via the stack 406. Convection tubes 410 may be formed as a bank of coils that carry a flow of hydrocarbon feedstock from a source thereof to the radiant tubes of the radiant section. Perforated distributor plate 418 is disposed within convection section 404 beneath the convection coils 410 in order to prevent flow channeling of the hot flue gas as it flows into the convection section. It is envisioned that the perforated distributor plate 418 may be located in a lower ¼ of the convection section. The perforated distributor plate is situated at least ½ the width of the tube bundle from the convection tubes, but no more than twice the width of the tube bundle from the convection tubes. Alternatively or additionally, the perforated distributor plate may have a plurality of holes that form a free open area in a range from 0.1% to 5.5%. It is further envisioned that the perforated distributor plate may have a thickness of 3 to 13 mm.

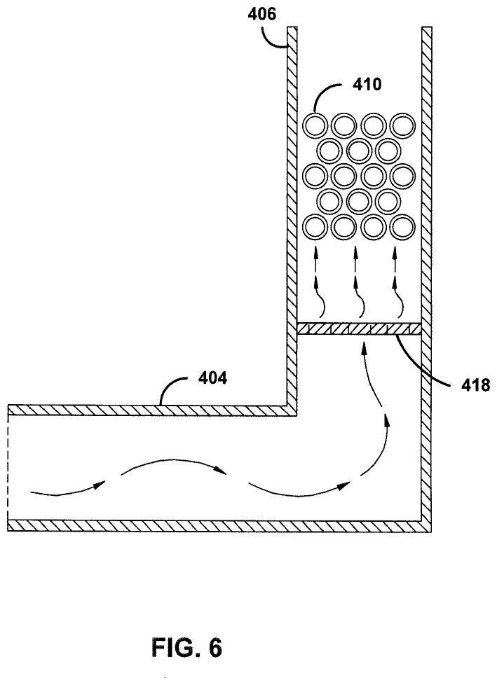

Turning to FIG. 6, perforated distributor plate 418 ensures that flue gas flow is not skewed towards one side of the convection tubes 410 due to the side entrance of the flue gases to the convection section 404 from the radiant section. The perforated distributor plate 418 is configured to provide a uniform flow distribution such that substantially no flue gas flow channeling is evident by velocity or mass flow distribution in an area immediately below the convection tubes 410 after passing of the hot flue gas through the perforated distributor plate 418. For example, the uniform flow distribution is evidenced in that flue gas flow rate in one tube area is not greater than flue gas flow rate in any other tube area by 5% to 10% of average flow rate. Alternatively or additionally, the plate produces a change in flow distribution such that the difference in the flow rates on each side of the convection tubes is changed to be less than 10% of average flow rate. Hence, uniform heating of the convection tubes 410 occurs in which the side of the convection tubes 410 furthest from the side entrance of the flue gases from the radiant section is not overheated, and the side of the convection tubes 410 nearest to the side entrance of the flue gases from the radiant section is not less heated. For example, the uniform heating is evidenced in that a difference in temperature between the tube areas on each side of the convection tubes is not greater than 5% of average temperature. As a result, the problems of accelerated feed coke formation and failure to fully vaporize the feed before it enters the radiant section tubes are avoided.

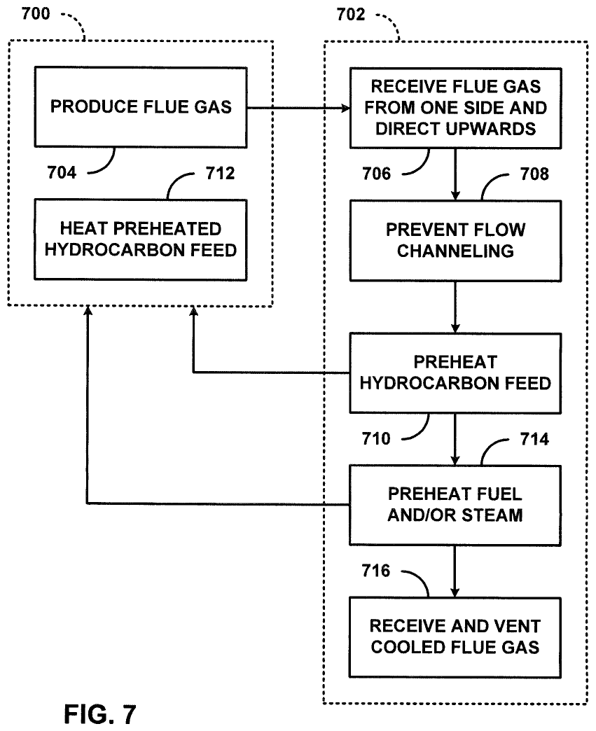

Turning to FIG. 7, a method of operation for the furnace of FIG. 4 may be characterized as two parallel processes, including a radiant section process 700 and a convection section process 702. The radiant section process 700 may begin, at block 704, by burning fuel in the radiant section of the furnace to produce radiant heat and flue gas. Thereafter, the convection section process may begin, at block 706, by receiving the flue gas from the radiant section. In block 706, it is envisioned that the flue gas may be received from one side and directed upwards. Convection section process 702 may continue, at block 708, by preventing flow channeling of the flue gas as the flue gas flows into proximity with hydrocarbon feed flowing through convection tubes, as previously described. The prevention of flow channeling of the flue gas at block 708 may be accomplished by employing the perforated distribution plate described above. For example, block 708 may include providing a uniform flow distribution such that no flue gas flow channeling is evident by velocity or mass flow distribution immediately prior to preheating the hydrocarbon feed after preventing flow channeling. This condition can be observed in that the difference in the flow rates on each side of the convection tubes is less than 10% of average flow rate. Convection section process 702 may continue, at block 710, by preheating hydrocarbon feed using convection of heat from the hot flue gas. The preheating of the hydrocarbon feed at block 708 is improved by the prevention of flow channeling of the hot flue gas at block 708. The improvement is evident in the more even heating of the feedstock, which reduces coking and increases vaporization of the feedstock, as previously described.

With the feedstock preheated at block 710, the radiant section process 700 may continue, at block 712, by heating the preheated hydrocarbon feed while continuing to produce hot flue gas at block 704. It is additionally envisioned that convection section process 702 may also continue by preheating, at block 714, fuel and/or steam, as previously described. It is further envisioned that radiant section process 700 may employ the preheated fuel and/or steam in producing radiant heat and flue gas, as previously described. Alternatively or additionally, it is envisioned that one or more of the preheated fuel and/or steam may be employed in other processes, as will be readily apparent to one skilled in the art. Convection section process may further proceed, at block 716, by receiving cooled flue gas and discharging the cooled flue gas to the atmosphere.

Although embodiments of the present application and their advantages have been described in detail, it should be understood that various changes, substitutions and alterations can be made herein without departing from the spirit and scope of the embodiments as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the above disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

1. A furnace comprising:
a convection section that comprises convection tubes disposed in a convection compartment, the convection tubes adapted to receive hydrocarbon feed and to preheat the hydrocarbon feed primarily by convection of heat from hot flue gas that flows into the convection section, the convection section comprising a perforated distributor plate adapted to prevent flow channeling of the hot flue gas as it flows into the convection section; and
a radiant section that comprises radiant tubes disposed in a radiant compartment, the radiant tubes in fluid communication with the convection tubes so that preheated hydrocarbon feed flows from the convection section to the radiant section, the radiant section adapted to burn fuel and heat the preheated hydrocarbon feed primarily by radiation and from the hot flue gas, wherein the furnace is adapted so that the hot flue gas flows from the radiant section into the convection section.

2. The furnace as claimed in claim 1, further comprising a stack section for receiving cooled flue gas from the convection section and discharging the cooled flue gas to the atmosphere.

3. The furnace as claimed in claim 1, wherein the perforated distributor plate is located in a lower ¼ of the convection section.

4. The furnace as claimed in claim 1, wherein the perforated distributor plate has a plurality of holes that form a free open area in a range from 0.1% to 5.5%.

5. The furnace as claimed in claim 1, wherein a difference in temperature between tube areas on each side of the convection tubes is not greater than 5% of average temperature.

6. The furnace as claimed in claim 1, wherein the perforated distributor plate is configured to provide a uniform flow distribution such that no flue gas flow channeling is evident by velocity or mass flow distribution in an area immediately below the convection tubes after passing of the hot flue gas through the perforated distributor plate.

7. The furnace as claimed in claim 1, wherein the perforated distributor plate has a thickness of 3 to 13 mm.

8. The furnace as claimed in claim 1, wherein the hot flue gas enters the convection section and passes through the distributor plate before encountering the convection tubes.

9. The furnace as claimed in claim 1, wherein the hot flue gas enters the convection section from one side and passes upwardly through the distributor plate.

10. The furnace as claimed in claim 1, wherein the convection section is adapted so that the hot flue gas also preheats at least one of fuel or steam.

11. An apparatus comprising:
means for preheating hydrocarbon feed by convection of heat from hot flue gas;
means for preventing flow channeling of the hot flue gas as it flows into proximity with the hydrocarbon feed; and
means for heating the preheated hydrocarbon feed and producing the hot flue gas.

12. The apparatus as claimed in claim 11, further comprising:
means for receiving cooled flue gas and discharging the cooled flue gas to the atmosphere.

13. The apparatus as claimed in claim 11, wherein the means for preventing flow channeling is configured to provide a uniform flow distribution such that no flue gas flow channeling is evident by velocity or mass flow distribution in an area immediately below the means for preheating hydrocarbon feed after passing of the hot flue gas through the means for preventing flow channeling.

14. The apparatus as claimed in claim 11, further comprising means for receiving the hot flue gas from one side and directing the hot flue gas to pass upwardly through the means for preventing flow channeling before the hot flue gas encounters the means for preheating hydrocarbon feed.

15. The apparatus as claimed in claim 11, further comprising: means for preheating at least one of fuel or steam by convection of heat from hot flue gas.

16. A method comprising:
preheating hydrocarbon feed by convection of heat from hot flue gas;
preventing flow channeling of the hot flue gas as it flows into proximity with the hydrocarbon feed; and
heating the preheated hydrocarbon feed and producing the hot flue gas.

17. The method as claimed in claim 16, further comprising receiving cooled flue gas and discharging the cooled flue gas to the atmosphere.

18. The method as claimed in claim 16, wherein the preventing flow channeling includes providing a uniform flow distribution such that no flue gas flow channeling is evident by velocity or mass flow distribution immediately prior to preheating the hydrocarbon feed after the preventing flow channeling.

19. The method as claimed in claim 16, further comprising:
receiving the hot flue gas from one side; and
directing the hot flue gas to pass upwardly for the preventing flow channeling before the hot flue gas is used for the preheating hydrocarbon feed.

20. The method as claimed in claim 16, further comprising preheating at least one of fuel or steam by convection of heat from hot flue gas.
